(19) United States
(12) Patent Application Publication
(10) Pub. No.: US 2018/0114136 A1
(43) Pub. Date: Apr. 26, 2018

(54) TREND IDENTIFICATION USING MULTIPLE DATA SOURCES AND MACHINE LEARNING TECHNIQUES

(71) Applicant: Accenture Global Solutions Limited, Dublin (IE)

(72) Inventors: Sheethal KUMAR, Edina, MN (US); Milton Jay Merl, New York, NY (US); Sudhir Holla, Frisco, TX (US); Raghavendra Rao B, Bangalore (IN); Wade J. Olson, Minnetonka, MN (US); Sridhar KUNCHALA, Hyderabad (IN); Pragya C. SHARMA, Mumbai (IN); Surendra KUSHWAHA, Bangalore (IN)

(21) Appl. No.: 15/786,087

(22) Filed: Oct. 17, 2017

(30) Foreign Application Priority Data
Oct. 21, 2016 (IN) 201641036121

(51) Int. Cl. G06N 7/00; G06F 15/18; G06Q 30/02

(52) U.S. Cl. CPC G06N 7/005; G06Q 50/01; G06Q 30/0201; G06F 15/18

(57) ABSTRACT

A device may receive, from a set of data sources, information associated with a topic. The device may determine a set of directional scores associated with the topic based on the information associated with the topic. The device may determine a set of sentiment scores associated with the topic based on the information associated with the topic. The device may determine, using a model, a trend score based on the set of directional scores and the set of sentiment scores. The device may provide information that identifies the trend score to permit an action to be performed.

### RELATED APPLICATION(S)

This application claims priority under 35 U.S.C. § 119 to Indian Provisional Patent Application 201641036121, filed on Oct. 21, 2016, the content of which is incorporated by reference herein in its entirety.

### BACKGROUND

Data points, from various data sources, may include information associated with a topic. A user (e.g., an analyst) may be required to analyze the data points to identify particular information associated with the topic.

### SUMMARY

According to some possible implementations, a device may include one or more processors to receive, from a set of data sources, information associated with a topic; determine a set of directional scores associated with the topic based on the information associated with the topic, the set of directional scores corresponding to the set of data sources, and the set of directional scores being indicative of a variation in a number of data points associated with the topic across a set of time frames; determine a set of sentiment scores associated with the topic based on the information associated with the topic, the set of sentiment scores corresponding to the set of data sources, and the set of sentiment scores being indicative of a sentiment associated with the topic; determine, using a model, a trend score based on the set of directional scores and the set of sentiment scores, the trend score being indicative of the variation in the number of data points and the sentiment associated with the topic; and provide information that identifies the trend score to permit an action to be performed.

According to some possible implementations, a method may include receiving, by a device and from a set of data sources, information associated with a topic; determining, by the device, a set of directional scores associated with the topic based on the information associated with the topic, the set of directional scores corresponding to the set of data sources, and the set of directional scores being indicative of a variation in a number of data points associated with the topic across a set of time frames; determining, by the device, a set of sentiment scores associated with the topic based on the information associated with the topic, the set of sentiment scores corresponding to the set of data sources, and the set of sentiment scores being indicative of a sentiment associated with the topic; determining, by the device, a trend score based on the set of directional scores, the set of sentiment scores and a model, the trend score being indicative of the variation in the number of data points and the sentiment associated with the topic; and providing, by the device, information that identifies the trend score to permit an action to be performed.

According to some possible implementations, a non-transitory computer-readable medium may store one or more instructions that, when executed by one or more processors, cause the one or more processors to receive, from a set of data sources, information associated with a topic; determine a set of directional scores associated with the topic based on the information associated with the topic, the set of directional scores corresponding to the set of data sources, and the set of directional scores being indicative of a variation in a number of data points associated with the topic across a set of time frames; determine a set of sentiment scores associated with the topic based on the information associated with the topic, the set of sentiment scores corresponding to the set of data sources, and the set of sentiment scores being indicative of a sentiment associated with the topic; determine a trend score based on the set of directional scores, the set of sentiment scores and a model, the trend score being indicative of the variation in the number of data points and the sentiment associated with the topic; and provide information that identifies the trend score to permit and/or cause an action to be performed.

### BRIEF DESCRIPTION OF THE DRAWINGS

FIG. 1 is a diagram of an overview of an example implementation described herein;

FIG. 2 is a diagram of an example environment in which systems and/or methods, described herein, may be implemented;

FIG. 3 is a diagram of example components of one or more devices of FIG. 2;

FIG. 4 is a flow chart of an example process for determining a trend score associated with a topic; and

FIGS. 5A-5D are diagrams of an example implementation relating to the example process shown in FIG. 4.

### DETAILED DESCRIPTION

The following detailed description of example implementations refers to the accompanying drawings. The same reference numbers in different drawings may identify the same or similar elements.

A topic may be associated with a particular importance depending on a time period. For example, a topic may exhibit a trend across time periods (e.g., increase, decrease, or persist in importance). An analyst may attempt to manually identify trends associated with topics and/or may attempt to identify topics that are associated with particular trends. However, manual identification of trends may be dependent on user knowledge of the information, may involve excessive manual work, may be error-prone, may be incomplete, may be subjective, or the like.

For example, in the procurement and/or retail industry, an analyst may desire to identify items (e.g., products, goods, themes, etc.) that are associated with particular trends and/or that may be associated with particular trends (e.g., may attempt to proactively identify a trend). That is, the analyst may attempt to distinguish ephemeral fads versus more permanent trends. Often, the analyst may have access to incomplete information, and thus may erroneously classify and/or fail to predict particular trends.

Some implementations described herein provide a trend platform (e.g., a set of cloud servers that may execute a web-based tool that user devices may access via client applications) to receive, from multiple data sources, information associated with topics. Additionally, some implementations described herein enable the trend platform to identify relationships between topics. Still further, some implementations described herein enable the trend platform to determine a directional score based on a number of data points that include a topic (e.g., which may be indicative of a popularity of the topic per a time frame), and a sentiment score based on a sentiment associated with the topic (e.g., whether a sentiment is positive, negative, ambivalent, etc.). Further, some implementations described herein enable the trend platform to implement machine learning techniques to determine a trend score based on the directional score and/or the sentiment score. In this way, some implementations described herein improve trend identification associated with topics by enabling the trend platform to utilize information from multiple disparate data sources (e.g., social media websites, or the like), and determine trend scores based on the information. Additionally, in this way, some implementations described herein reduce an amount of manual processing associated with trend identification, reduce subjectivity associated with trend identification, etc. In this way, some implementations described herein conserve computing resources of devices associated with trend identification by reducing an amount of processing needed to identify trends, such as in situations where additional processing is performed based on subjectively identified trends, erroneous identification of trends, or the like.

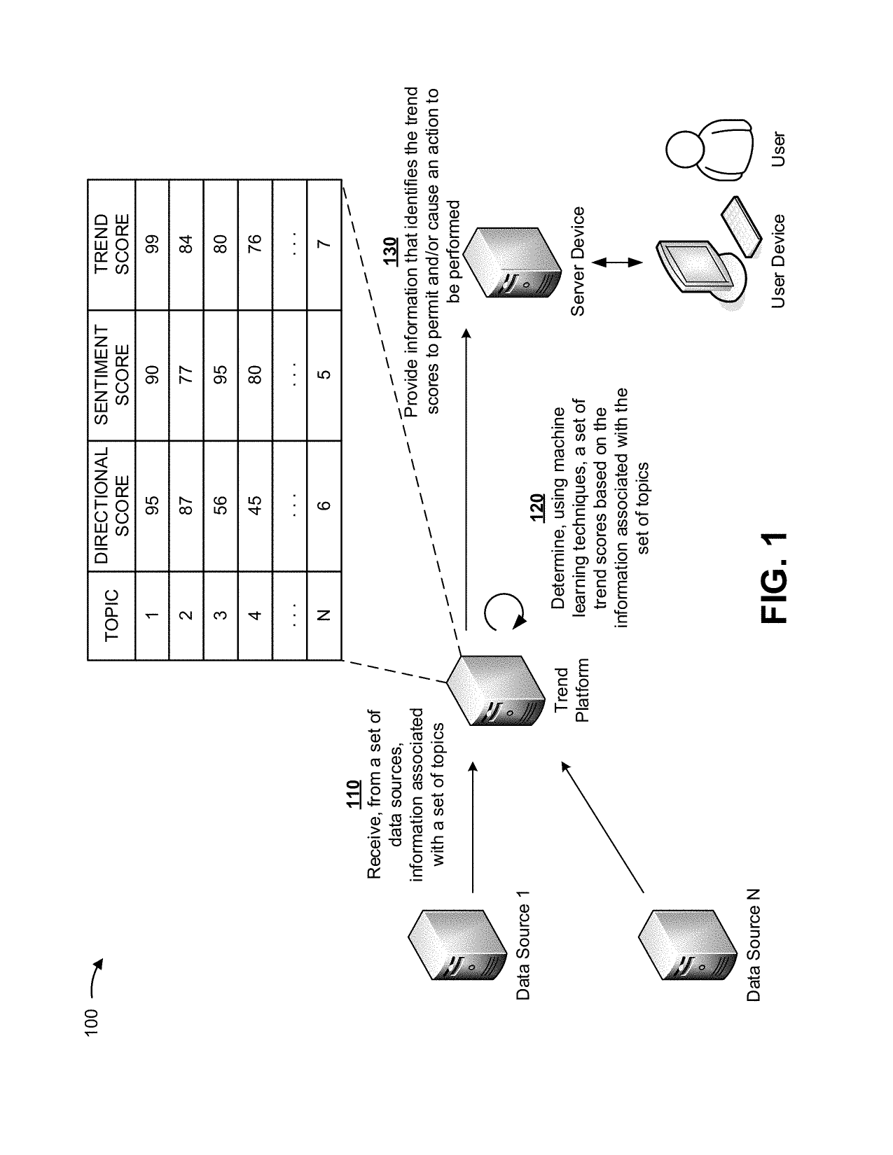

FIG. 1 is a diagram of an overview of an example implementation 100 described herein. As shown in FIG. 1, example implementation 100 may include a trend platform, a server device, a user device, and multiple data sources.

As further shown in FIG. 1, and by reference number 110, the trend platform may receive, from the data sources, information associated with a set of topics. In some implementations, a topic may relate to an entity, an object, a product, a characteristic, an attribute, or the like.

In some implementations, the data sources may be associated with social media services, blogs, or the like. In some implementations, the information associated with a set of topics may identify topics, data sources, resources, temporal indicators, or the like. As described elsewhere herein, the trend platform may use the information associated with the set of topics to determine trend scores associated with the set of topics.

As further shown in FIG. 1, and by reference number 120, the trend platform may determine, using machine learning techniques, a set of trend scores based on the information associated with the set of topics. In some implementations, a trend score may indicate a trend associated with a topic (e.g., a popularity of the topic, a sentiment associated with the topic, etc.).

In some implementations, the trend platform may determine a trend score for a topic based on determining a directional score associated with the topic (e.g., identifying an increase, a decrease, a stagnation, etc. of a number of data points that relate to the topic). Additionally, or alternatively, the trend platform may determine a trend score for a topic based on determining a sentiment score (e.g., indicating a sentiment) associated with the topic.

In some implementations, the trend platform may use machine learning techniques (e.g., artificial networks, learning automata, decision trees, association rule learning, etc.) to determine the trend score. In some implementations, the trend platform may generate a model based on known directional scores, known sentiment scores, and/or known trends. Additionally, the trend platform may use the model to determine trend scores. For example, and as described elsewhere herein, the trend platform may input various parameters into the model, and determine a trend score based on inputting the various parameters.

As further shown in FIG. 1, and by reference number 130, the trend platform may provide information that identifies the trend scores to permit and/or cause an action to be performed. In some implementations, the trend platform may provide the information to the user device, which may provide, for display via a user interface, the information.

In some implementations, the trend platform may provide the information that identifies the trend scores to the server device. In some implementations, the trend platform may cause an action to be performed based on causing a product and/or a service, associated with a topic, to be purchased and/or requested based on a trend score associated with the topic.

In this way, some implementations described herein improve trend identification associated with topics by enabling the trend platform to utilize information from multiple disparate data sources (e.g., social media websites, or the like).

As indicated above, FIG. 1 is provided merely as an example. Other examples are possible and may differ from what was described with regard to FIG. 1.

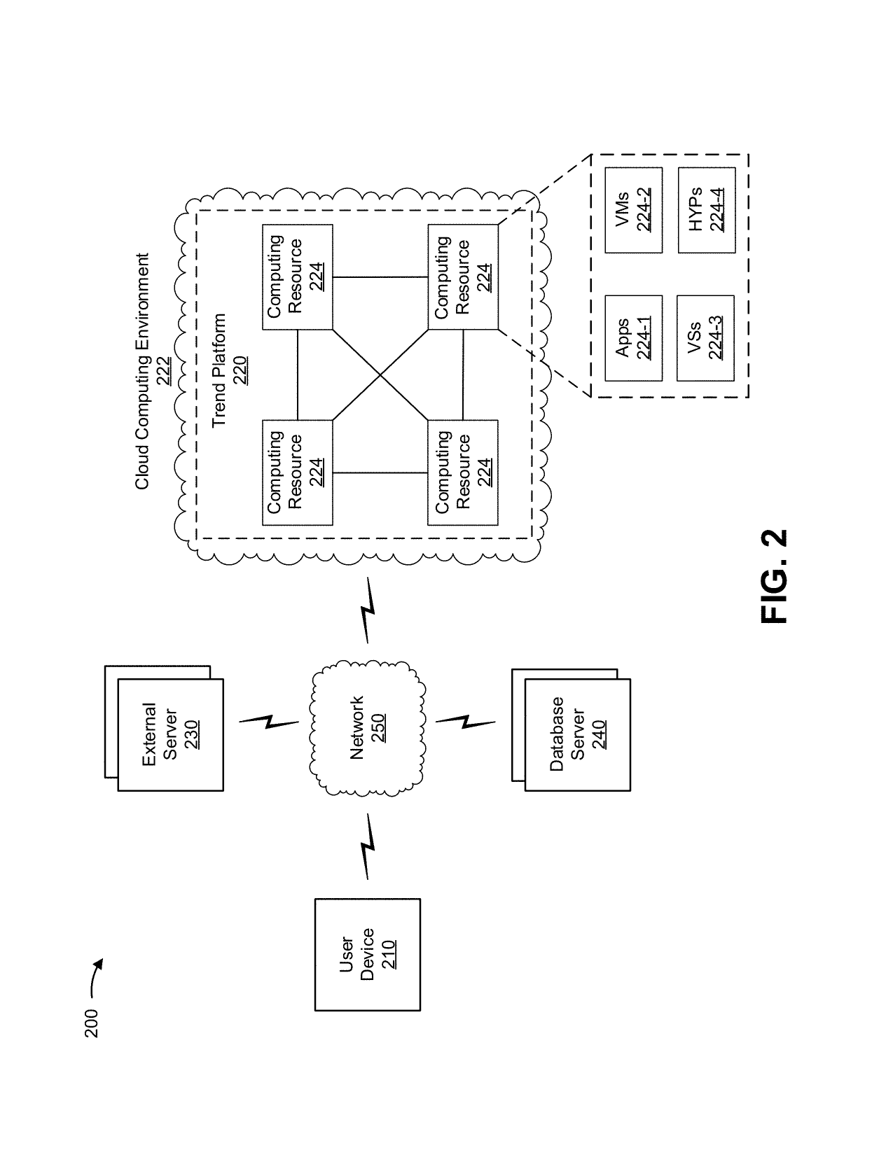

FIG. 2 is a diagram of an example environment 200 in which systems and/or methods, described herein, may be implemented. As shown in FIG. 2, environment 200 may include a user device 210, a trend platform 220, external servers 230, database servers 240, and a network 250. Devices of environment 200 may interconnect via wired connections, wireless connections, or a combination of wired and wireless connections.

User device 210 includes one or more devices capable of receiving, generating, storing, processing, and/or providing information associated with trend platform 220. For example, user device 210 may include a computing device, such as a desktop computer, a laptop computer, a tablet computer, a handheld computer, a server device, a mobile phone (e.g., a smart phone or a radiotelephone), a wearable communication device (e.g., a smart wristwatch, an activity band, or a pair of smart eyeglasses), a gaming device, or a similar type of device.

Trend platform 220 includes one or more devices capable of determining a trend score associated with a topic. In some implementations, trend platform 220 may be designed to be modular such that certain software components can be swapped in or out depending on a particular need. As such, trend platform 220 may be easily and/or quickly reconfigured for different uses.

In some implementations, as shown, trend platform 220 may be hosted in cloud computing environment 222. Notably, while implementations described herein describe trend platform 220 as being hosted in cloud computing environment 222, in some implementations, trend platform 220 may not be cloud-based (i.e., may be implemented outside of a cloud computing environment) or may be partially cloud-based.

Cloud computing environment 222 includes an environment that hosts trend platform 220. Cloud computing environment 222 may provide computation, software, data access, storage, etc. services that do not require end-user (e.g., user device 210) knowledge of a physical location and configuration of system(s) and/or device(s) that hosts trend platform 220. As shown, cloud computing environment 222 may include a group of computing resources 224 (referred to collectively as “computing resources 224” and individually as “computing resource 224”).

Computing resource 224 includes one or more personal computers, workstation computers, server devices, or other types of computation and/or communication devices. In some implementations, computing resource 224 may host trend platform 220. The cloud resources may include compute instances executing in computing resource 224, storage devices provided in computing resource 224, data transfer devices provided by computing resource 224, etc. In some implementations, computing resource 224 may communicate with other computing resources 224 via wired connections, wireless connections, or a combination of wired and wireless connections.

As further shown in FIG. 2, computing resource 224 includes a group of cloud resources, such as one or more applications (“APPs”) 224-1, one or more virtual machines (“VMs”) 224-2, virtualized storage (“VSs”) 224-3, one or more hypervisors (“HYPs”) 224-4, or the like.

Application 224-1 includes one or more software applications that may be provided to or accessed by client device 205. Application 224-1 may eliminate a need to install and execute the software applications on client device 205. For example, application 224-1 may include software associated with trend platform 220 and/or any other software capable of being provided via cloud computing environment 222. In some implementations, one application 224-1 may send/receive information to/from one or more other applications 224-1, via virtual machine 224-2.

Virtual machine 224-2 includes a software implementation of a machine (e.g., a computer) that executes programs like a physical machine. Virtual machine 224-2 may be either a system virtual machine or a process virtual machine, depending upon use and degree of correspondence to any real machine by virtual machine 224-2. A system virtual machine may provide a complete system platform that supports execution of a complete operating system (“OS”). A process virtual machine may execute a single program, and may support a single process. In some implementations, virtual machine 224-2 may execute on behalf of a user (e.g., client device 205), and may manage infrastructure of cloud computing environment 222, such as data management, synchronization, or long-duration data transfers.

Virtualized storage 224-3 includes one or more storage systems and/or one or more devices that use virtualization techniques within the storage systems or devices of computing resource 224. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 224-4 may provide hardware virtualization techniques that allow multiple operating systems (e.g., “guest operating systems”) to execute concurrently on a host computer, such as computing resource 224. Hypervisor 224-4 may present a virtual operating platform to the guest operating systems, and may manage the execution of the guest operating systems. Multiple instances of a variety of operating systems may share virtualized hardware resources.

External server 230 includes one or more devices, accessible through network 250, that are sources of information that may be used by trend platform 220. For example, external server 230 may include a server that includes particular information for use by trend platform 220 and/or user device 210. For example, external server 230 may include a server or a group of servers (e.g., a cloud-based server, an application device, a content server, a host server, a web server, a database server, etc.), a desktop computer, or a similar device. In some implementations, trend platform 220 may receive, from multiple external servers 230, information associated with a set of topics. For example, various external servers 230 may provide information associated with social media posts, sales figures, weblog posts, articles, search engine analytics metrics, or the like.

Database server 240 includes one or more devices capable of receiving, storing, and/or providing information for use by trend platform 220. For example, database server 240 may include a server or a group of servers. In some implementations, database server 240 may provide, to trend platform 220, information and/or resources. In some implementations, trend platform 220 may receive, from multiple database servers 240, information associated with a set of topics. For example, various database servers 240 may provide information that identifies relationships between topics, sub-topics, etc.

Network 250 includes one or more wired and/or wireless networks. For example, network 250 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

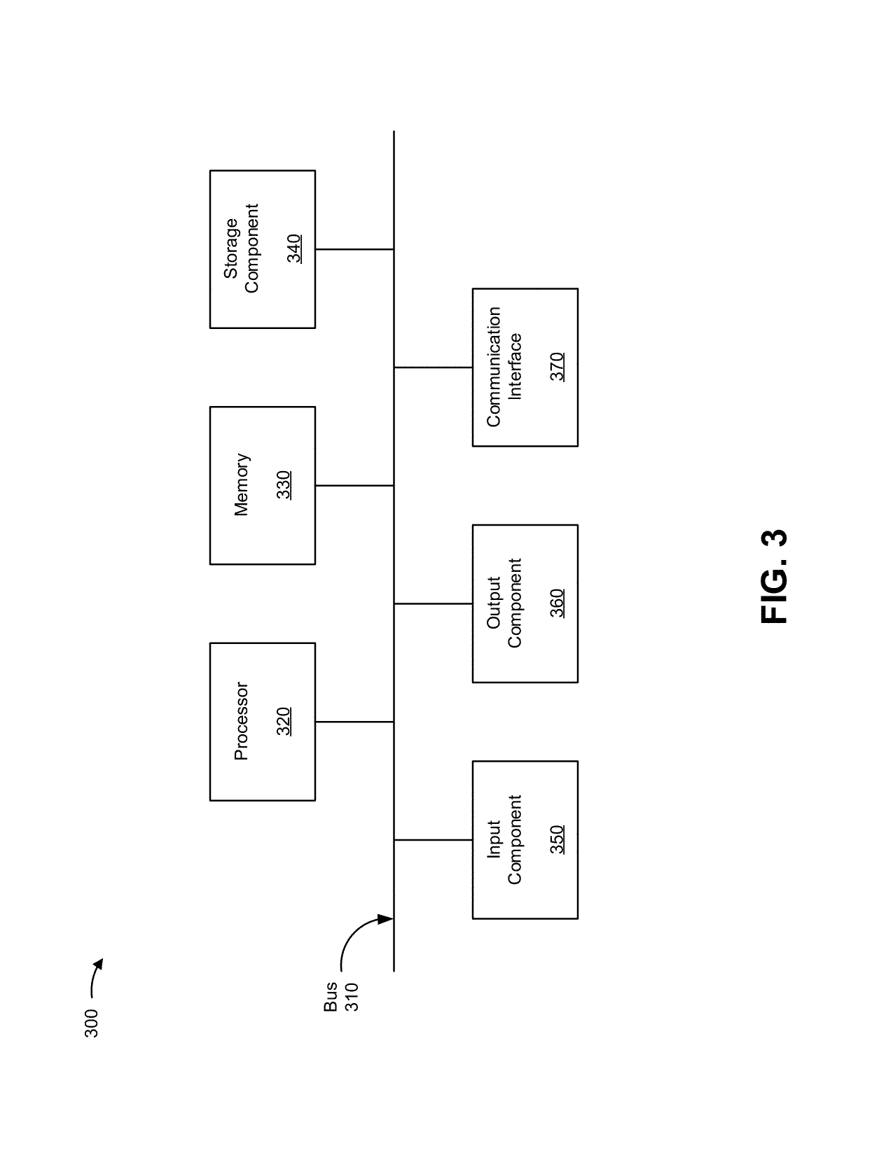

FIG. 3 is a diagram of example components of a device 300. Device 300 may correspond to user device 210, trend platform 220, external server 230, and/or database server 240. In some implementations, user device 210, trend platform 220, external server 230, and/or database server 240 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 includes a component that permits communication among the components of device 300. Processor 320 is implemented in hardware, firmware, or a combination of hardware and software. Processor 320 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

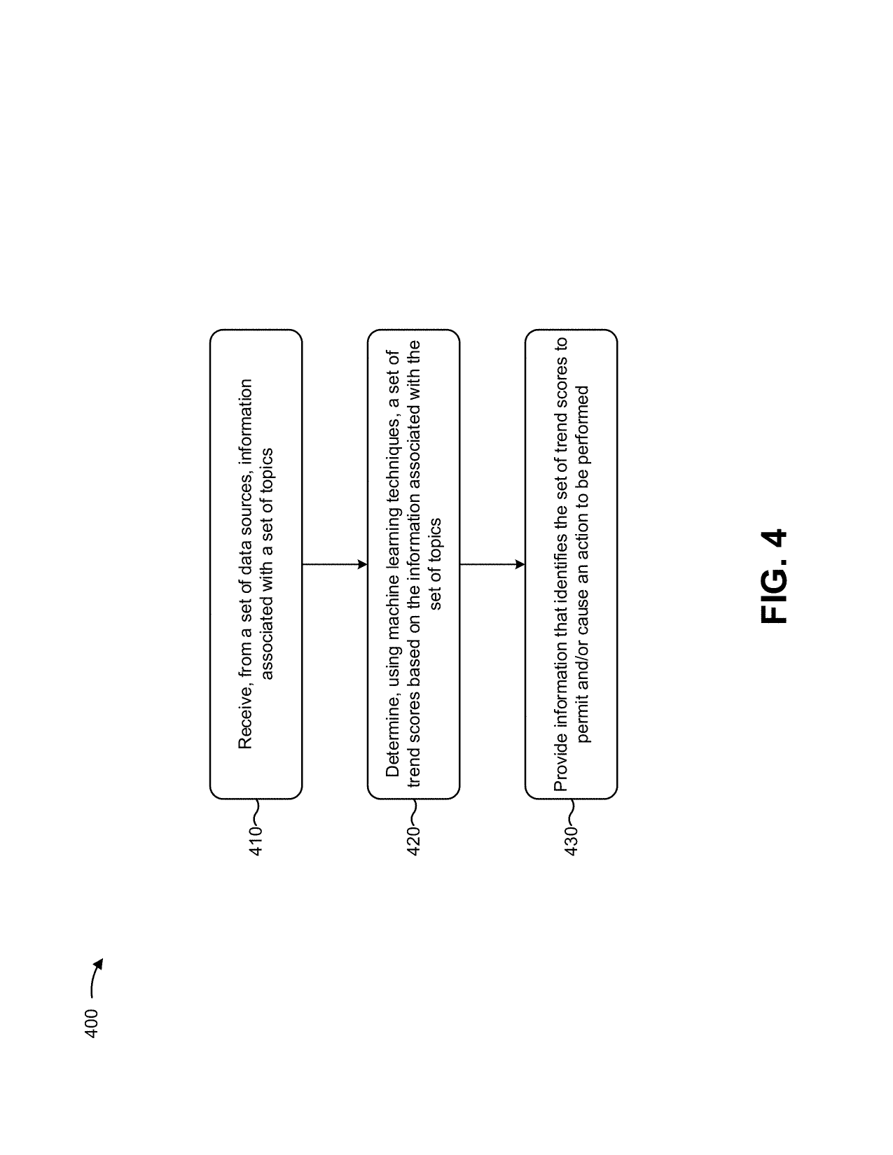

FIG. 4 is a flow chart of an example process 400 for determining a trend score associated with a topic. In some implementations, one or more process blocks of FIG. 4 may be performed by trend platform 220. In some implementations, one or more process blocks of FIG. 4 may be performed by another device or a group of devices separate from or including trend platform 220, such as user device 210, external server 230, and/or database server 240.

As shown in FIG. 4, process 400 may include receiving, from a set of data sources, information associated with a set of topics (block 410). For example, trend platform 220 may receive, from external server 230 and/or database server 240, information associated with a set of topics. In some implementations, and as described elsewhere herein, trend platform 220 may determine trend scores associated with the set of topics. For example, a user may utilize trend platform 220 to identify particular topics that are associated with particular trend scores.

In some implementations, a topic may refer to an entity, an object, a product, a characteristic, an attribute, a theme, or the like. Additionally, or alternatively, a topic may be associated with a set of sub-topics, and/or a sub-topic may be associated with another set of sub-topics. In other words, a hierarchy may define a relationship between topics and sub-topics.

In some implementations, trend platform 220 may receive, from user device 210, information that identifies a set of topics. For example, user device 210 may receive, based on a user input, information that identifies particular topics. As an example, an entity may desire to identify trend scores associated with particular topics. In this case, trend platform 220 may identify information associated with the particular topics. Additionally, or alternatively, trend platform 220 may identify information associated with particular topics without having received an input from user device 210 that identifies the topics (e.g., may perform an information extraction technique and identify latent topics, or the like).

In some implementations, trend platform 220 may receive, from user device 210, information that identifies a particular set of data sources. For example, a user may desire that trend platform 220 determine trend scores using information associated with a particular set of data sources. Additionally, or alternatively, trend platform 220 may receive, from user device 210, information that identifies a frequency for which trend platform 220 is to receive the information from the set of data sources for trend identification.

By utilizing information associated with a particular set of data sources, trend platform 220 improves accuracy of trend identification as compared to situations where trend platform 220 identifies trends based on information associated with data sources that are not selected by a user, that are not desired by a user as candidate data sources, or the like. In this way, trend platform 220 may identify trends in a manner that more closely aligns with a user preference, thereby reducing an amount of processing required as compared to situations where a user causes trend platform 220 to perform multiple iterations of trend identification.

By increasing a frequency for which information is received, trend platform 220 improves accuracy of trend identification as compared to situations where trend platform 220 determines trends based on outdated information. Alternatively, by reducing a frequency at which information is received, trend platform 220 conserves processor and/or memory resources and/or network resources by reducing a number of API calls, reducing an amount of information retrieval, or the like, in association with situations where a higher frequency of information retrieval is not required for accurate trend identification (e.g., where trends may be accurately identified despite a lower frequency of information retrieval).

In some implementations, trend platform 220 may receive, from multiple data sources, information associated with the set of topics. For example, trend platform 220 may utilize one or more application programming interfaces (APIs) (e.g., an Alchemy API, an IBM Bluemix API, an IBM Watson API, a SEMrush API, an Apache API, or the like) to receive information from respective data sources (e.g., associated with external servers 230 and/or database servers 240). While implementations herein describe particular APIs, other implementations include other APIs.

In some implementations, the information associated with the set of topics may include structured data, semi-structured data, non-structured data, or the like. For example, structured, semi-structured, and non-structured may refer to the extent to which data is organized according to a particular format. In some implementations, trend platform 220 may utilize different processing techniques based on whether the information associated with the set of topics is structured, semi-structured, or non-structured. Additionally, or alternatively, trend platform 220 may utilize different processing techniques based on a data source associated with the information. As an example, trend platform 220 may receive, from a first data source (e.g., a social media service), information that is associated with a particular format (e.g., a JavaScript object notation (JSON) file), whereas trend platform 220 may receive, from a second data source (e.g., a social media blog), information that is associated with another format (e.g., a text file).

In some implementations, the information associated with the set of topics may include a resource (e.g., a document, a webpage, a weblog post, a social media account post, an email, a file, an image file, an audio file, a video file, a spreadsheet file, or the like). Additionally, or alternatively, the information associated with the set of topics may include a resource identifier (e.g., a uniform resource identifier (URI), a uniform resource locator (URL), a uniform resource name (URN), a network address, a database address, or the like).

In some implementations, the information associated with the set of topics may include a resource associated with a particular file type and/or format (e.g., a JavaScript object notation (JSON) file, a hypertext markup language (HTML) file, an extensible markup language (XML) file, a text file, a joint photographic experts group (JPEG) file, a portable document format (PDF) file, or the like). Additionally, or alternatively, the information associated with the user may include a resource associated with a particular source (e.g., a user that generated the information, a device that stores the resource, or the like).

In some implementations, trend platform 220 may receive, from user device 210, information associated with the set of topics and/or a memory location at which the information associated with the set of topics is stored. In some implementations, trend platform 220 may use one or more APIs to receive the information associated with the set of topics. Additionally, or alternatively, trend platform 220 may perform a technique (e.g., a web crawling technique, a web scraping technique, a data mining technique, a web searching technique, a database searching technique, or the like), and receive information, associated with the set of topics, to be processed based on the technique.

In some implementations, trend platform 220 may correlate the information, associated with the set of topics, and metadata (e.g., temporal information, geolocation information, etc.). In some implementations, the information, associated with the set of topics, may include one or more temporal indicators. For example, a temporal indicator may indicate a time, a date, a time frame, a time interval, a time period, or the like (e.g., a timestamp, or the like). In some implementations, a temporal indicator may indicate when the information was created, modified, or the like. For example, a temporal indicator may include a date and/or a time associated with the information (e.g., 30 Jun. 2013), and/or may indicate that the information is pertinent to a particular time and/or date. Additionally, or alternatively, a temporal indicator may identify a time period associated with the information (e.g., Quarter 1 (Q1) 2015 or simply 2015).

In some implementations, trend platform 220 may standardize the information to prepare the information for processing. As an example, trend platform 220 may standardize information associated with different file types and/or different formats, such that the information is represented in association with a particular file type and/or particular format. In some implementations, trend platform 220 may standardize the information based on a data source associated with the information. For example, trend platform 220 may use a first standardization technique in association with information from a first data source, and use a second standardization technique in association with information from a second data source, or the like. In some implementations, trend platform 220 may identify a file type and/or format associated with the information, and determine a technique to standardize the information based on the file type and/or format.

In some implementations, trend platform 220 may standardize the information such that the information includes a common format of data, such as text. In some implementations, trend platform 220 may prepare the text for processing by adjusting characters in the text, such as by removing characters, replacing characters, adding characters, adjusting a font, adjusting formatting, adjusting spacing, removing white space, or the like. For example, trend platform 220 may replace multiple spaces with a single space, insert a space after a left parenthesis, a left brace, a left bracket, etc., and/or insert a space before a right parenthesis, a right brace, a right bracket, etc.

In this way, trend platform 220 may use a space delimiter to more easily parse the text, thereby conserving processor and/or memory resources of trend platform 220. In some implementations, trend platform 220 may further prepare the text for processing by expanding acronyms in the text, determining terms in the text (e.g., by determining characters identified by one or more delimiting characters), associating part-of-speech tags (POS tags) with terms in the text, or the like.

In some implementations, trend platform 220 may generate a corpus of terms (e.g., a term corpus) by generating a data structure that stores terms extracted from the text (e.g., the standardized information). A term may refer to a set of characters, such as a single character, multiple characters (e.g., a character string), a combination of characters that form multiple words (e.g., a multi-word term, such as a phrase, a sentence, or a paragraph), a combination of characters that form an acronym, a combination of characters that form an abbreviation of a word, a combination of characters that form a misspelled word, or the like. By generating the data structure that stores terms extracted from the text, trend platform 220 may process the text more efficiently than if the text were processed without first generating the data structure, thereby conserving processor and memory resources.

In some implementations, trend platform 220 may receive information that identifies particular terms to be used to perform topic identification (e.g., a topic corpus). For example, trend platform 220 may identify terms that are associated with the topic corpus, and compare the terms associated with the topic corpus and terms associated with the term corpus. As an example, trend platform 220 may determine that a term, included in the term corpus, matches a term included in the topic corpus, and identify information associated with a topic based on the match (e.g., a topic identified by the terms).

Additionally, or alternatively, trend platform 220 may implement a technique, such as an information weighting technique, an information retrieval technique, a text mining technique, or the like, to identify particular topics based on the terms. For example, trend platform 220 may determine term frequency-inverse document frequency (tf-idf) scores for the terms, and identify topics based on terms that include particular tf-idf scores (e.g., tf-idf scores that satisfy a threshold, a top set of tf-idf scores, or the like). As an example, the tf-idf score for a term may indicate a measure of relative importance of the term as compared to other terms.

In some implementations, trend platform 220 may identify a set of topics based on relevance scores. For example, a relevance score may identify a relevance of a first topic to a second topic. As an example, assume that user device 210 provide, to trend platform 220, information identifying a first topic. In this case, trend platform 220 may identify a set of other topics that are related to the first topic. For example, trend platform 220 may identify a set of related topics based on a graph data structure (e.g., using a traversal technique, a graph processing technique, or the like), as described below.

In some implementations, trend platform 220 may store, in a data structure (e.g., a data structure that is local to trend platform 220, a data structure that is external to trend platform 220, or the like), information associated with the set of topics. For example, trend platform 220 may store the information in a graph data structure. In some implementations, a graph data structure (e.g., herein also referred to as a “graph”) may refer to a data structure that represents data in a graph format (e.g., a knowledge graph, a knowledge base, or the like). In some implementations, the graph may include a set of nodes and a set of edges that are associated with the set of nodes. For example, the set of nodes may correspond to topics and the set of edges may correspond to relationships between topics.

In some implementations, trend platform 220 may store, in a data structure, information that is associated with a topic. For example, trend platform 220 may store information such as a number of data points (e.g., weblog posts, social media posts, or the like) that include the topic, information that identifies the data points, information that identifies sources of the data points, or the like. In this way, trend platform 220 may determine a trend score for a topic based on the information, as described below.

As further shown in FIG. 4, process 400 may include determining, using machine learning techniques, a set of trend scores based on the information associated with the set of topics (block 420). For example, trend platform 220 may determine, using machine learning techniques, a set of trend scores based on the information associated with the set of topics. In some implementations, and as described elsewhere herein, trend platform 220 may determine a directional score and a sentiment score for a topic, and determine a trend score for the topic based on a model and the directional score and the sentiment score.

In some implementations, trend platform 220 may determine a directional score associated with a topic. In some implementations, a directional score may signify a popularity of a topic, an interest in the topic, a value associated with the topic, a demand for the topic, or the like. As an example, a first topic that is associated with a greater directional score than as compared to a second topic may be more popular, may be in greater demand, may be of more importance, or the like, than as compared to the second topic.

In some implementations, a directional score may identify an increase, a decrease, a stagnation, or the like, of a number of data points that include the topic across time frames. In some implementations, trend platform 220 may determine a directional score based on a number of data points that include (e.g., mention, discuss, involve, etc.) a topic for a first time frame, and a number of data points that include the topic for a second time frame. For example, trend platform 220 may compare a first number of data points that include the topic for a first time frame and a second number of data points that include the topic for a second time frame, and determine the directional score based on the comparison.

In some implementations, trend platform 220 may determine respective numbers of data points for a set of time frames (e.g., ten time frames, one hundred time frames, one thousand time frames, etc.), and determine a directional score based on the respective numbers of data points. In some implementations, trend platform 220 may implement an averaging technique and determine an average number of data points (e.g., a simple moving average, a weighted average, a median, a mean, or the like). In some implementations, trend platform 220 may apply various weight values to different time frames, and determine the average (e.g., a weighted average) based on the weight values. For example, particular time frames may be of more importance than other time frames in relation to directional scores.

In some implementations, trend platform 220 may determine a set of directional scores for a topic based on a set of data sources. For example, trend platform 220 may receive, from multiple external servers 230 and/or database servers 240, information associated with a topic, and determine directional scores that correspond to information received from the various data sources.

In some implementations, trend platform 220 may receive thousands, millions, etc. of data points from various data sources. For example, trend platform 220 may receive information associated with multiple social media services, multiple weblogs, multiple websites, or the like.

In some implementations, trend platform 220 may implement different techniques to determine directional scores on a data source basis. For example, and in association with a data source associated with a social media service, trend platform 220 may determine a directional score based on directional indicators, such as posts, comments, likes, dislikes, up-votes, down-votes, shares, etc. that are associated with a topic. Additionally, or alternatively, different social media services may be associated with different types of data points and/or different types of directional indicators that trend platform 220 may use to determine directional scores.

As another example, and in association with a weblog, trend platform 220 may determine a directional score based on a number of weblog posts that are associated with the topic, a number of times the topic is mentioned in a weblog post or posts, a number of comments associated with a weblog post, a number of shares of a weblog post, or the like. As another example, and in association with search engine analytics data, trend platform 220 may determine a directional score based on a number of searches for a topic, a number of searches for keywords associated with a topic, page ranks associated with websites associated with the topic, or the like.

In some implementations, trend platform 220 may apply weight values to various directional scores. For example, trend platform 220 may assign weights to different directional scores, associated with different data sources, differently. As a particular example, assume that a first data source (e.g., a first weblog) is associated with a first page rank that is greater than a second page rank associated with a second data source (e.g., a second weblog). In this case, trend platform 220 may assign a greater weight to a directional score associated with the first data source as compared to the second data source.

In some implementations, trend platform 220 may apply a first directional score associated with a first topic to a second topic (e.g., a related topic, a sub-topic of the first topic, or the like). For example, trend platform 220 may identify related topics using a graph data structure, as described elsewhere herein. Additionally, trend platform 220 may attribute a directional score of a topic to a related topic (e.g., because an increase in popularity of a particular topic may also indicate an increase in popularity of related topics).

In some implementations, trend platform 220 may determine a sentiment score associated with a topic. For example, a sentiment score may indicate a sentiment associated with a topic. In some implementations, a sentiment score may indicate a sentiment, such as an opinion, a view, an attitude, a feeling, an emotion, a regard, or the like, associated with a topic. As an example, a first sentiment score may indicate a positive sentiment towards a topic (e.g., that the topic is generally well regarded by entities). Alternatively, and as another example, a second sentiment score may indicate a negative sentiment (e.g., that the topic is generally not well regarded by entities).

In some implementations, trend platform 220 may implement one or more techniques to determine a sentiment score associated with a topic. For example, trend platform 220 may perform a sentiment analytics technique, a natural language processing (NLP) technique, an opinion mining technique, an artificial intelligence (AI) technique, or the like, to determine a sentiment score.

In some implementations, trend platform 220 may determine a set of sentiment scores for a topic based on a set of data sources. That is, trend platform 220 may determine multiple sentiment scores for a topic based on various information associated with the set of data sources. In other words, trend platform 220 may determine a first sentiment score using information associated with a first data source, a second sentiment score using information associated with a second data source, etc. By determining multiple sentiment scores associated with a topic, trend platform 220 increases accuracy of trend identification as compared to situations where trend platform 220 determines a single sentiment score associated with a single data source.

In some implementations, trend platform 220 may determine a sentiment score for a topic based on data associated with an external server 230 that is associated with a social media service. In this case, trend platform 220 may identify a number of data points (e.g., posts, or the like) that include the topic. Additionally, trend platform 220 may identify sentiment indicators associated with the data points (e.g., up votes, down votes, likes, dislikes, comments including terms with positive sentiment, comments including terms with negative sentiment, comments including terms with neutral sentiment, or the like). Additionally, trend platform 220 may determine a sentiment score, for the data source (e.g., associated with the external server 230), based on the sentiment indicators.

In some implementations, trend platform 220 may determine a sentiment score based on data associated with an external server 230 that is associated with unstructured data (e.g., a weblog, a website, or the like). For example, trend platform 220 may use an NLP technique to identify terms associated with the unstructured data.

In some implementations, trend platform 220 may identify terms that occur within a threshold distance of a term that identifies the topic. Additionally, trend platform 220 may identify a sentiment associated with the terms. For example, trend platform 220 may access information (e.g., via a local data structure, a remote data structure, or the like) that maps terms and sentiment associated with the terms. Additionally, or alternatively, trend platform 220 may determine a sentiment score associated with the topic based on respective sentiments of the terms. As an example, trend platform 220 may determine a sentiment score that indicates a positive sentiment associated with a topic in situations where terms, that occur within a threshold distance of the topic, are associated with positive sentiment.

In some implementations, trend platform 220 may identify a set of terms associated with the unstructured data, and determine a sentiment score associated with the topic based on sentiments of the terms. For example, trend platform 220 may identify unique terms that occur within the unstructured data (e.g., a weblog post), determine sentiments associated with the unique terms, and determine a sentiment score of the topic based on the sentiments. In other words, if an overall sentiment associated with the weblog post is positive, then trend platform 220 may determine a sentiment score that is indicative of a positive sentiment.

In some implementations, trend platform 220 may determine a directional score and/or a sentiment score for a topic based on a geolocation and/or a demographic. For example, trend platform 220 may identify geolocation information and/or demographic information associated with data points received from external servers 230 and/or database servers 240, and correlate particular directional scores and/or sentiment scores with a particular geolocation and/or a particular demographic. As an example, a topic may be associated with varying popularity and/or sentiment based on different geolocations, different demographics, or the like. In other words, a popularity and/or sentiment associated with a topic may vary between geolocations and/or demographics.

In some implementations, trend platform 220 may use machine learning techniques to analyze data (e.g., training data, such as historical data, data associated with known trends, etc.) and create models. The machine learning techniques may include, for example, supervised and/or unsupervised techniques, such as artificial networks, Bayesian statistics, learning automata, Hidden Markov Modeling, linear classifiers, quadratic classifiers, decision trees, association rule learning, or the like.

In some implementations, trend platform 220 may use another kind of computer-implemented technique, such as AI, machine perception, or computer vision, to analyze data and determine trends. In some implementations, trend platform 220 may receive information that identifies a set of topics associated with known directional scores and sentiment scores and information associated with a set of known trend scores. Additionally, trend platform 220 may generate a model based on the known directional scores, sentiment scores, and trend scores.

In some implementations, trend platform 220 may create a model using information associated with a first set of topics, and use the model in association with information relating to a second set of topics. Additionally, or alternatively, trend platform 220 may receive, based on determining a set of trend scores, additional information that identifies known trend scores of the set of topics, and may update the model based on the additional information.

In some implementations, the trend score may be indicative of a trend associated with a topic. In some implementations, trend platform 220 may determine, for a topic, a first trend score based on high (e.g., indicating greater popularity) directional scores, and/or high sentiment scores (e.g., indicating more positive sentiment). That is, the first trend score may be indicative of a topic being associated with an increase (or a persistence) in popularity and an increase (or persistence) in positive sentiment across time frames. In this case, the first trend score may be indicative of the topic being in high demand, being well regarded, being associated with high interest, or the like.

As another example, trend platform 220 may determine a trend score that is indicative of a topic being associated with a low popularity yet a positive sentiment (e.g., indicating that the topic is well regarded despite not being in particularly high demand). As another example, trend platform 220 may determine a trend score that is indicative of a topic being associated with a high popularity yet a negative sentiment (e.g., indicating that interest in the topic is high despite a generally negative connotation). As yet another example, trend platform 220 may determine a trend score that is indicative of a low popularity and a low sentiment (e.g., indicating that interest in the topic is low and that the topic is generally not well regarded). While implementations herein describe particular trend scores and particular characteristics associated with the trend scores, it should be understood that other implementations include other trend scores that are associated with different characteristics.

In some implementations, trend platform 220 may determine a trend score for a topic based on trend scores associated with related topics. For example, trend platform 220 may identify a set of related topics using a graph data structure, and determine a trend score for a topic based on the trend scores of the related topics. For example, trend platform 220 may input information that identifies trend scores associated with related topics, sub-topics, etc. into a model, and determine a trend score for a topic based on the trend scores associated with the related topics, sub-topics, etc. By using information associated with related topics and/or sub-topics, trend platform 220 more accurately identifies trends than as compared to situations where such information is not utilized. In other words, by identifying and utilizing information associated with related topics, trend platform 220 more accurately identifies trends associated with a particular topic.

In some implementations, trend platform 220 may determine a trend score for a topic based on trend scores associated with sub-topics. For example, as described elsewhere herein, a topic may be associated with a set of sub-topics, the set of sub-topics may further include another set of sub-topics, etc. In such cases, trend platform 220 may identify different permutations of sub-topics, and determine a trend score based on trend scores of the sub-topics. As an example, assume that a topic relates to a vehicle. In this case, the topic may be associated with various sub-topics, such as type of vehicle (e.g., sports car, SUV, sedan, minivan, etc.). Further, the topic may be associated with other sub-topics, such as a particular manufacturer, a particular model type, a particular color, etc. In this case, different permutations of sub-topics and the topic may be associated with different trend scores. As an example, a black SUV associated with a luxury manufacturer may include a trend score that indicates persistent popularity and positive sentiment, whereas a red minivan associated with another manufacturer may be associated with another trend score that is indicative of a low popularity and a negative sentiment.

In some implementations, trend platform 220 may input a set of parameters (e.g., that correspond to a set of directional scores, a set of sentiment scores, and/or other metrics) using the model, and determine a set of trend scores for the set of topics. For example, trend platform 220 may input, for a topic, information identifying a set of directional scores associated with different data sources, different geolocations, different demographics, or the like, and a set of sentiment scores associated with different data sources, different geolocations, different demographics, or the like. Additionally, or alternatively, trend platform 220 may input information identifying a number of data points associated with the topic, a number of data sources associated with the data points, or the like. Additionally, or alternatively, trend platform 220 may input, for a topic, information identifying a set of directional scores and/or a set of sentiment scores associated with related topics, sub-topics, or the like. In some implementations, trend platform 220 may determine a trend score for the topic based on inputting the various parameters.

In some implementations, trend platform 220 may determine multiple trend scores for a topic. For example, trend platform 220 may determine trend scores for the topic for different time frames. In some implementations, trend platform 220 may perform an averaging technique using the set of trend scores, and determine a single trend score. Alternatively, trend platform 220 may use, when providing the information that identifies the trend score, a particular trend score. By determining multiple trend scores associated with a topic, trend platform 220 improves accuracy of trend identification by reducing a number of false positives such as situations where trend platform 220 identifies an ephemeral trend instead of a more permanent trend, and provides information that identifies the ephemeral trend and causes an action to be performed based on the ephemeral trend.

In some implementations, trend platform 220 may determine that a difference in trend scores, associated with a topic, satisfies a threshold. For example, trend platform 220 may identify that a particular topic is associated with a trend score that is fluctuating quickly, that has increased by a substantial margin, that has decreased by a substantial margin, or the like. In this way, trend platform 220 may identify a trend based on respective trend scores associated with a topic. As an example, a situation where a topic is associated with a substantial change in trend scores may more accurately identify a trend than as compared to situations where the topic is associated with generally equivalent trend scores (e.g., generally high trend scores, generally low trend scores, etc.).

In some implementations, trend platform 220 may determine that a trend score associated with a particular topic satisfies a threshold difference between trend scores associated with related topics. For example, trend platform 220 may determine that a trend score associated with the particular topic is substantially greater than trend scores associated with related topics, is substantially less than trend scores associated with related topics, etc. In this way, trend platform 220 improves accuracy of trend identification based on comparing trend scores associated with related topics and identifying particular topics that are associated with trend scores that exhibit a discrepancy.

As further shown in FIG. 4, process 400 may include providing information that identifies the set of trend scores to permit and/or cause an action to be performed (block 430). For example, trend platform 220 may provide information that identifies the set of trend scores to permit and/or cause an action to be performed.

In some implementations, trend platform 220 may perform the action by causing user device 210 to provide, for display, information associated with the set of trend scores. In some implementations, trend platform 220 may identify a particular number of topics that include trend scores that satisfy a threshold (e.g., the top ten topics, the top five topics, the top three topics, etc.), and provide information that identifies the particular topics.

In some implementations, trend platform 220 may identify a set of related topics, compare trend scores associated with the related topics, and provide information that identifies particular topics based on comparing the trend scores. As an example, assume that a set of related topics (e.g., a first type of consumer good) includes a set of trend scores, and that a particular topic (e.g., a particular consumer good of the first type) includes a particular trend score that is much greater relative to the other trend scores.

Further, assume that the particular trend score is less than trend scores associated with another set of related topics (e.g., a second type of consumer good). In this case, trend platform 220 may provide information that identifies the particular topic (e.g., the first type of consumer good) despite the trend score being less than other trend scores. In some implementations, a difference between a trend score and trend scores of related topics may more accurately identify a trend as compared to a difference between a trend score and trend scores of unrelated topics. In other words, by comparing trend scores on a related topic basis, trend platform 220 may more accurately identify particular trends.

In some implementations, trend platform 220 may identify a topic that includes a trend score that satisfies a threshold, and identify a set of other topics (e.g., peripheral topics, ancillary topics, sub-topics, etc.). For example, trend platform 220 may use a graph data structure to identify a set of other topics that include particular relationships with the topic. In this way, trend platform 220 may provide, to user device 210, information that identifies the other topics, thereby enabling user device 210 to provide, for display via a user interface, the information associated with the other topics. Additionally, in this way, an entity may identify the set of other topics which may aid in decision making.

In some implementations, trend platform 220 may perform the action by causing a message (e.g., an email or a short message service (SMS) message) to be sent to user device 210. In this way, trend platform 220 may notify a user that a topic is associated with a particular trend score. Additionally, in this way, trend platform 220 may notify a user of particular information associated with a topic and may reduce a need of the user to cause user device 210 to perform a search for the information, thereby conserving processor and/or memory resources of user device 210.

In some implementations, trend platform 220 may perform the action by coordinating user devices 210. For example, trend platform 220 may coordinate client devices 205 (e.g., coordinate calendar applications associated with user devices 210 to schedule a meeting), and may provide information identifying a set of topics and/or trend scores (e.g., to be displayed in association with a calendar application).

In some implementations, trend platform 220 may perform the action by causing a budget associated with an entity to be updated based on trend scores associated with particular topics. For example, trend platform 220 may identify that particular topics are associated with particular trend scores, and cause a budget to be updated to accommodate procurement of goods associated with the particular topics.

In some implementations, trend platform 220 may perform the action by permitting a user to access text and/or a resource associated with a topic. For example, trend platform 220 may provide information (e.g., for display via user device 210) identifying and/or including resources (e.g., documents, etc.) that include particular topics. In some implementations, trend platform 220 may provide information that identifies a particular resource associated with the topic (e.g., may provide a link, such as a hyperlink, to the document), or the like. In this way, trend platform 220 may assist a user in analyzing particular resources associated with a topic and/or verifying the accuracy of a trend score. Additionally, in this way, trend platform 220 may reduce a quantity of processing needed to perform a search for information associated with a topic, thereby conserving processor and/or memory resources of user device 210.

In some implementations, trend platform 220 may perform the action by causing a product and/or a service, associated with a topic, to be purchased and/or requested based on a trend score associated with the topic. As an example, an operator of trend platform 220 may sell products and/or offer particular services that utilize particular products. In some implementations, trend platform 220 may receive information that identifies particular products, particular types of products, etc. that an entity associated with the operator offers for sale, is capable of offering for sale, desires to offer for sale, or the like. Additionally, trend platform 220 may identify trend scores associated with the particular products, identify trend scores associated with products that are associated with the particular types of products, or the like. Additionally, trend platform 220 may automatically cause particular products to be purchased, such that the entity may offer the particular products for sale. For example, trend platform 220 may automatically provide, to a device associated with a manufacturer or supplier of the products, a request for a particular number of products.

In some implementations, trend platform 220 may automatically cause a campaign to be modified based on the trend scores. For example, assume that an advertising campaign is advertising particular items. In this case, trend platform 220 may automatically cause the campaign to be modified, such that particular items, associated with trend scores that satisfy a threshold, are advertised. For example, trend platform 220 may provide information to display devices (e.g., Internet of Things (IoT) devices, user devices 210, or the like) that causes the display devices to provide, for display, information associated with the particular items.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

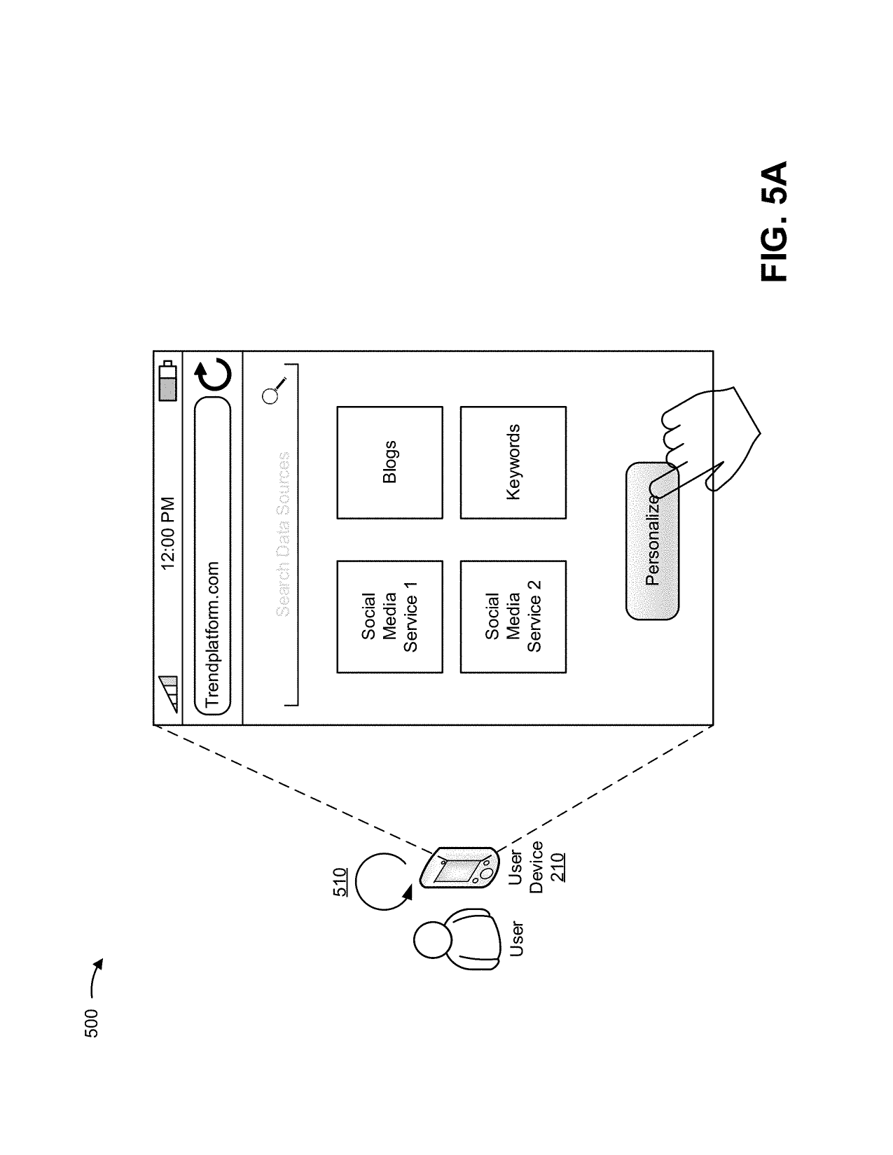

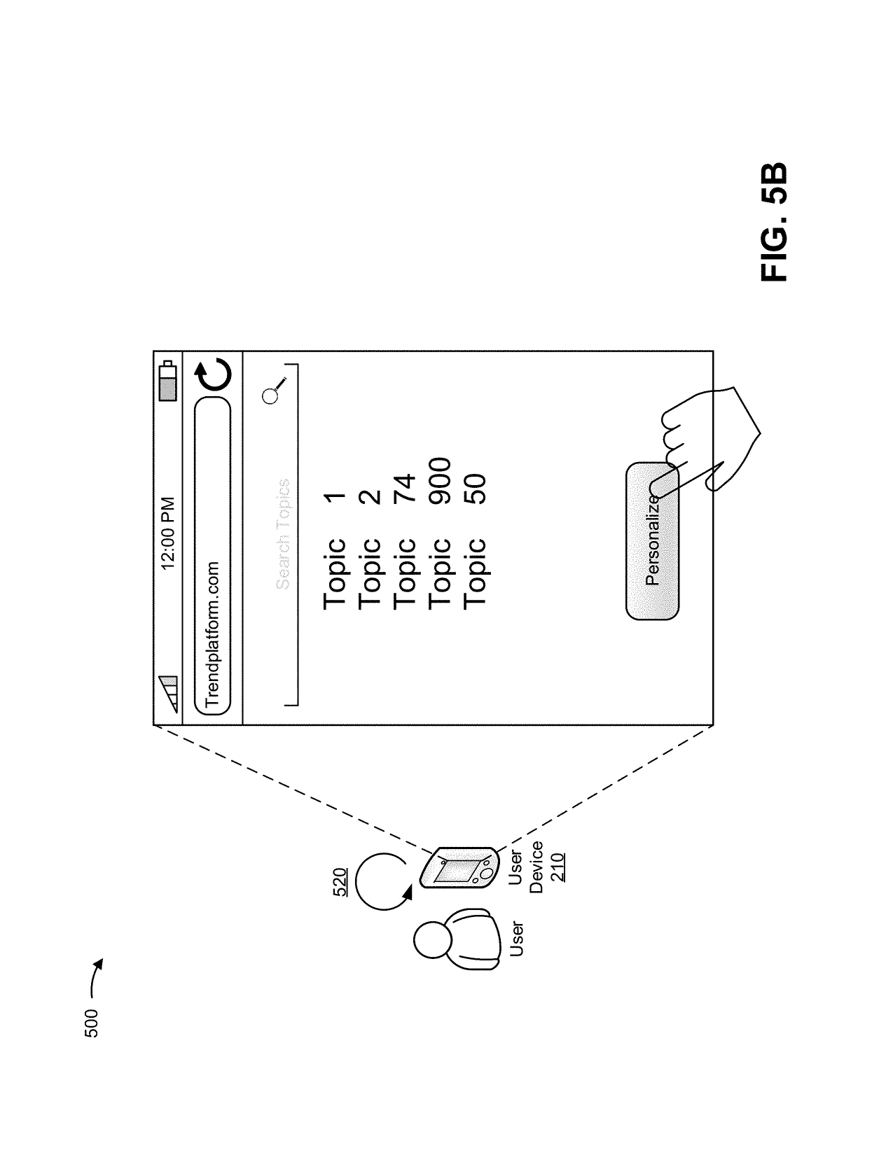

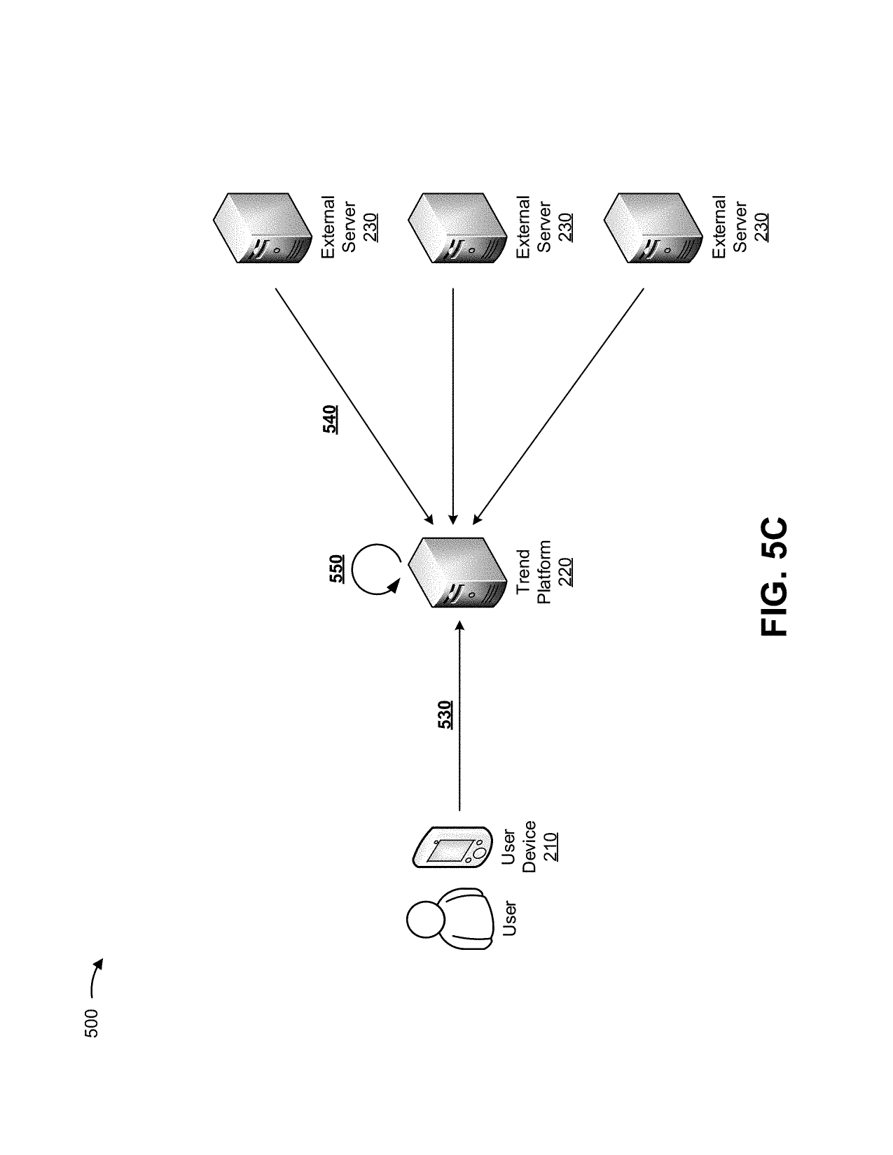

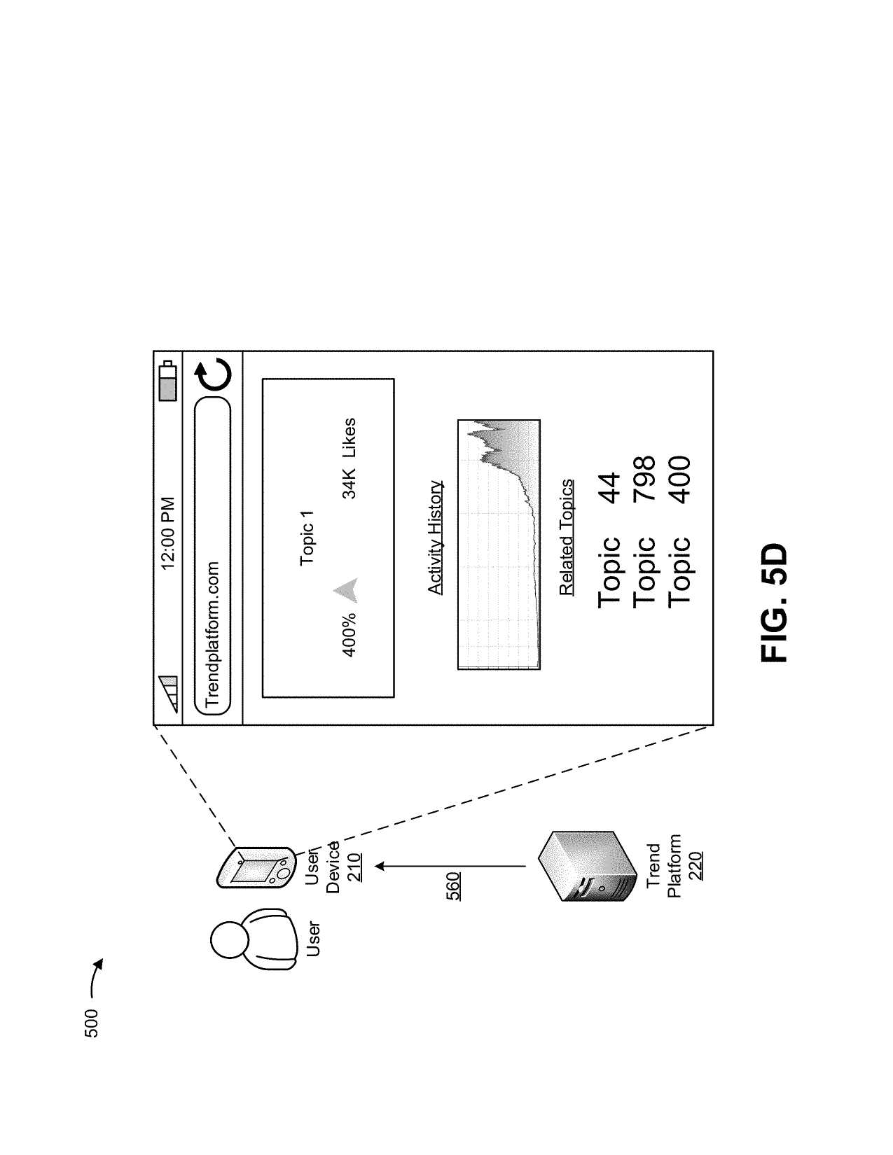

FIGS. 5A-5D are diagrams of an example implementation 500 relating to example process 400 shown in FIG. 4. FIGS. 5A-5D show an example of determining a trend score associated with a topic. As shown in FIGS. 5A-5D, example implementation 500 may include user device 210, trend platform 220, and external servers 230.

As shown in FIG. 5A, and by reference number 510, user device 210 may provide a user interface that allows a user to personalize trend identification performed by trend platform 220. For example, upon the user pressing a “personalize” button via the user interface, the user interface may enable the user to select particular data sources (e.g., social media service 1, social media service 2, blogs, keywords, etc.), as shown.

As shown in FIG. 5B, and by reference number 520, user device 210 may provide a user interface that enables the user to select particular topics (e.g., particular entities, objects, products, characteristics, attributes, etc.), shown as topic 1, topic 2, topic 74, topic 100, and topic 50.

As shown in FIG. 5C, and by reference number 530, trend platform 220 may receive, from user device 210, information associated with trend identification (e.g., the particular data sources selected by the user, the particular topics selected by the user, etc.). As shown by reference number 540, trend platform 220 may receive, from external servers 230, information associated with a set of topics. As shown by reference number 550, trend platform 220 may process the server information to determine a directional score, a sentiment score, and/or a trend score for each of the topics.

As shown in FIG. 5D, and by reference number 560, trend platform 220 may provide trend information (e.g., for topic 1, as shown) to user device 210 for display via a user interface of user device 210. As further shown, trend platform 220 may provide a graphical user interface element (e.g., an activity history graph representing activity associated with topic 1 over a period of time) to user device 210 for display.

As further shown in FIG. 5D, trend platform 220 may identify a set of related topics that are related to a particular topic. For example, trend platform 220 may identify a set of related topics based on a graph data structure (e.g., using a traversal technique, a graph processing technique, or the like), as described elsewhere herein. In this case, trend platform 220 may provide the related topics to user device 210 for display.

As indicated above, FIGS. 5A-5D are provided merely as an example. Other examples are possible and may differ from what was described with regard to FIGS. 5A-5D.

Some implementations described herein provide a trend platform to receive, from multiple data sources, information associated with topics. Additionally, some implementations described herein enable the trend platform to identify relationships between topics. Still further, some implementations described herein enable the trend platform to determine a directional score based on a number of data points that include a topic (e.g., which may be indicative of a popularity of the topic per a time frame), and a sentiment score based on a sentiment associated with the topic (e.g., whether a sentiment is positive, negative, ambivalent, etc.). Further, some implementations described herein enable the trend platform to implement machine learning techniques to determine a trend score based on the directional score and/or the sentiment score. In this way, some implementations described herein improve trend identification associated with topics by enabling the trend platform to utilize information from multiple disparate data sources (e.g., social media websites, or the like).

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, and/or a combination of hardware and software.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, or the like.

Certain user interfaces have been described herein and/or shown in the figures. A user interface may include a graphical user interface, a non-graphical user interface, a text-based user interface, etc. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A device, comprising:
one or more processors to:
receive, from a set of data sources, information associated with a topic;
determine a set of directional scores associated with the topic based on the information associated with the topic,
the set of directional scores corresponding to the set of data sources, and
the set of directional scores being indicative of a variation in a number of data points associated with the topic across a set of time frames;
determine a set of sentiment scores associated with the topic based on the information associated with the topic,
the set of sentiment scores corresponding to the set of data sources, and
the set of sentiment scores being indicative of a sentiment associated with the topic;
determine, using a model, a trend score based on the set of directional scores and the set of sentiment scores,
the trend score being indicative of the variation in the number of data points and the sentiment associated with the topic; and
provide information that identifies the trend score to permit an action to be performed.

2. The device of claim 1, where the one or more processors are further to:
identify, for the set of time frames, the number of data points associated with the topic; and
where the one or more processors, when determining the set of directional scores, are to:
determine the set of directional scores based on the number of data points and the set of time frames.

3. The device of claim 1, where the one or more processors are further to:
identify, using a graph data structure, another topic based on the trend score associated with the topic,
the other topic being associated with the topic; and
provide information that identifies the other topic.

4. The device of claim 1, where the one or more processors are further to:
determine a first directional score, associated with information from a first data source of the set of data sources, using a first technique;
determine a second directional score, associated with information from a second data source of the set of data sources, using a second technique that is different than the first technique; and
where the one or more processors, when determining the trend score, are to:
determine the trend score based on the first directional score and the second directional score.

5. The device of claim 1, where the one or more processors are further to:
determine a first sentiment score, associated with information from a first data source of the set of data sources, using a first technique; and
determine a second sentiment score, associated with information from a second data source of the set of data sources, using a second technique that is different than the first technique; and
where the one or more processors, when determining the trend score, are to:
determine the trend score based on the first sentiment score and the second sentiment score.

6. The device of claim 1, where the one or more processors are further to:
receive, from a first data source of the set of data sources, a first subset of the information associated with the topic using a first application programming interface (API); and
receive, from a second data source of the set of data sources, a second subset of the information associated with the topic using a second API that is different than the first API; and
where the one or more processors, when determining the set of directional scores, are to:
determine the set of directional scores based on the first subset of the information associated with the topic and the second subset of the information associated with the topic.

7. The device of claim 1, where the one or more processors are further to:
identify a set of items associated with the topic; and
where the one or more processors, when providing the information that identifies the trend score, are to:
provide information that identifies the trend score and items associated with the topic.

8. A method, comprising:
receiving, by a device and from a set of data sources, information associated with a topic;
determining, by the device, a set of directional scores associated with the topic based on the information associated with the topic,
the set of directional scores corresponding to the set of data sources, and
the set of directional scores being indicative of a variation in a number of data points associated with the topic across a set of time frames;
determining, by the device, a set of sentiment scores associated with the topic based on the information associated with the topic,
the set of sentiment scores corresponding to the set of data sources, and
the set of sentiment scores being indicative of a sentiment associated with the topic;
determining, by the device, a trend score based on the set of directional scores, the set of sentiment scores and a model,
the trend score being indicative of the variation in the number of data points and the sentiment associated with the topic; and
providing, by the device, information that identifies the trend score to permit an action to be performed.

9. The method of claim 8, further comprising:
identifying, for the set of time frames, the number of data points associated with the topic; and
where determining the set of directional scores comprises:
determining the set of directional scores based on the number of data points and the set of time frames.

10. The method of claim 8, further comprising:
identifying, using a graph data structure, another topic based on the trend score associated with the topic,
the other topic being associated with the topic; and
providing information that identifies the other topic.

11. The method of claim 8, further comprising:
determining a first directional score, associated with information from a first data source of the set of data sources, using a first technique; and
determining a second directional score, associated with information from a second data source of the set of data sources, using a second technique that is different than the first technique.

12. The method of claim 8, further comprising:
determining a first sentiment score, associated with information from a first data source of the set of data sources, using a first technique; and
determining a second sentiment score, associated with information from a second data source of the set of data sources, using a second technique that is different than the first technique.

13. The method of claim 8, further comprising:
receiving, from a first data source, of the set of data sources, a first subset of the information associated with the topic using a first application programming interface (API); and
receiving, from a second data source, of the set of data sources, a second subset of the information associated with the topic using a second API that is different than the first API.

14. The method of claim 8, further comprising:
identifying a set of other topics that are associated with other trend scores that satisfy a threshold; and
providing information that identifies the set of other topics.

15. A non-transitory computer-readable medium storing instructions, the instructions comprising:
one or more instructions that, when executed by one or more processors, cause the one or more processors to:
receive, from a set of data sources, information associated with a topic;
determine a set of directional scores associated with the topic based on the information associated with the topic,
the set of directional scores corresponding to the set of data sources, and
the set of directional scores being indicative of a variation in a number of data points associated with the topic across a set of time frames;
determine a set of sentiment scores associated with the topic based on the information associated with the topic,
the set of sentiment scores corresponding to the set of data sources, and
the set of sentiment scores being indicative of a sentiment associated with the topic;
determine a trend score based on the set of directional scores, the set of sentiment scores and a model,
the trend score being indicative of the variation in the number of data points and the sentiment associated with the topic; and
provide information that identifies the trend score to permit and/or cause an action to be performed.

16. The non-transitory computer-readable medium of claim 15, where the one or more instructions, when executed by the one or more processors, further cause the one or more processors to:
identify, for the set of time frames, the number of data points associated with the topic; and
where the one or more processors, when determining the set of directional scores, are to:
determine the set of directional scores based on the number of data points and the set of time frames.

17. The non-transitory computer-readable medium of claim 15, where the one or more instructions, when executed by the one or more processors, further cause the one or more processors to:
identify, using a graph data structure, another topic based on the trend score associated with the topic
the other topic being associated with the topic; and
provide information that identifies the other topic.

18. The non-transitory computer-readable medium of claim 15, where the one or more instructions, when executed by the one or more processors, further cause the one or more processors to:
determine a first set of directional scores, associated with information from a first data source of the set of data sources, using a first technique; and
determine a second set of directional scores, associated with information from a second data source of the set of data sources, using a second technique that is different than the first technique.

19. The non-transitory computer-readable medium of claim 15, where the one or more instructions, when executed by the one or more processors, further cause the one or more processors to:
determine a first set of sentiment scores, associated with information from a first data source of the set of data sources, using a first technique; and
determine a second set of sentiment scores, associated with information from a second data source of the set of data sources, using a second technique that is different than the first technique.

20. The non-transitory computer-readable medium of claim 15, where the one or more instructions, when executed by the one or more processors, further cause the one or more processors to:
receive, from a first data source, of the set of data sources, a first subset of the information associated with the topic using a first application programming interface (API); and
receive, from a second data source, of the set of data sources, a second subset of the information associated with the topic using a second API that is different than the first API.
